(19) United States
(12) Patent Application Publication
(10) Pub. No.: US 2011/0062707 A1
(43) Pub. Date: Mar. 17, 2011

(54) SEALED MECHANICAL CONNECTION BETWEEN GLASS AND METAL FOR RECEIVER TUBES USED IN SOLAR PLANTS

(75) Inventors: Felipe Cantero Gutierrez, Sevilla (ES); Borja Gomez Rojo, Sevilla (ES); Noelia Martinez Sanz, Sevilla (ES); Angel Sedano Garcia, Sevilla (ES); Jose Goikoetxea Larrinaga, Sevilla (ES); Cristobal Villasante Corredoira, Sevilla (ES)

(73) Assignee: ABENGOA SOLAR NEW TECHNOLOGIES, S.A., Sevilla (ES)

(21) Appl. No.: 12/936,166

(22) PCT Filed: Apr. 1, 2009
(86) PCT No.: PCT/ES2009/000177

§ 371 Date: Nov. 19, 2010

(30) Foreign Application Priority Data
Apr. 3, 2008 (ES) P200800930

(51) Int. Cl. F16L 23/00; F16L 19/08

(52) U.S. Cl. 285/363; 285/382.7

(57) ABSTRACT

The invention relates to a sealed mechanical connection between glass and metal for receiver tubes used in solar plants of the type using a heat-transfer fluid, which uses a mechanical force in order to establish the seal between the inner metal tubes and the outer glass tubes, between which tubes a high vacuum is established in order to prevent heat losses. According to the invention, a flexible, deformable metal joint is used for the above-mentioned seal, which joint, when duly compressed, adapts to the corresponding surfaces of the tubes to be sealed, thereby establishing the seal between the respective tubes. In addition, the invention can include a continuous system for maintaining the necessary vacuum between both types of tubes.

The present invention, intended to be protected as Invention Patent, relates to a more reliable connection procedure between a glass and another metal tube in the manufacturing of receiver tubes used in solar plants in their different applications: power generation, heat production for heating and solar fuel production, as well as in various thermochemical processes.

### BACKGROUNDS OF THE INVENTION

Although the connection between a glass (brittle) and a metal (ductile) is a problem solved by the welding technique, much used, especially in the electronics field, when this technique is intended to be used in macro bodies, subjected to continuous temperature changes, breakages due to different expansion coefficients of one and other material are caused in the connections.

The absorber or receiver tubes are responsible for collecting the concentrated thermal energy of the sun thereon, whereby a heat-transfer fluid is flowed, which absorbs said energy to be subsequently used as energy source.

Solar plants operate at maximum temperatures close to 400° C. Due to the daily discontinuity of the energy resource, the sun, the absorber tubes are subjected to temperature changes between day and night ranging from 400° C. and 0° C. This makes parts constituting the receiver tubes to be subjected to strong thermal stresses.

Currently, the absorber tubes are formed by metal tubes through which flows a thermal fluid that absorbs the concentrated energy from the sun. Coaxially to them, glass tubes, made of borosilicate, and metal pieces, revolution bellows-shaped are arranged, which are connected through their outer circumference to glass tubes and through their inner circumference to metal tubes, thus enclosing spaces between both types of tubes (glass and metal). In said spaces, high vacuums are performed, thereby reducing heat losses characteristic of the high temperatures reached by the corresponding devices, thus making both receptors and solar plants more efficient. Due to the need of maintaining high vacuums, a completely sealed system between the described parts is required.

Currently, the sealing system, which allows the vacuum to be maintained inside the mentioned space, consists of a welded connection between the glass tube, made of borosilicate, and a metal piece, made of a material called Kovar® (alloy of iron, nickel and cobalt). This piece is backwardly connected to a bellows preventing the stresses to which the tube is subjected from affecting the connection.

This type of welded connection has breakage problems, in a low percentage of joints, but in significant amounts. When a breakage of the joint is produced, there is a sudden vacuum loss inside the tube and, at normal working temperatures and contacting the oxygen of the air, the selective coating of the inner metal tube is irreversibly damaged. Thus, after a breakage of this kind, the whole system is useless and must be replaced.

### DESCRIPTION OF THE INVENTION

To avoid the previous problems, the invention that is then set forth provides a connection between glass and metal maintaining the high required vacuum levels, with a very considerable reliability and durability. On the other hand, in case of failure, the sealing system will experience a progressive, and not sudden reduction of the vacuum level between the corresponding pats, which in many cases can prevent the irreversible damage of the respective device, as will be explained later.

The concept of sealed mechanical connection of the invention is based on the use of a flexible metal joint for high vacuum, called Helicoflex®, responsible for absorbing the force exerted by mechanical elements between a glass flange, located at the end of the glass tube, and a set of metal pieces. The flexible metal joint, located between the outside of the glass tube and the set of metal pieces, provides the property of adapting to surfaces to which it makes contact, by using a mechanical force, thus causing the needed sealing.

The inside vacuum will be performed, according to the desired level, by using any of the different conventional methods for this purpose, being able to be performed through a olive hole in the glass, or through a valve mounted on the metal sealing flange.

On the other hand in case of failure, the sealing system undergoes a progressive reduction of the vacuum level, always less than one atmosphere, a continuous system for maintaining the vacuum may eventually be provided, thus preventing the complete replacement of the tube in the event of failure in the sealing.

### DESCRIPTION OF THE DRAWINGS

For a better understanding of the invention, two figures are attached representing the following:

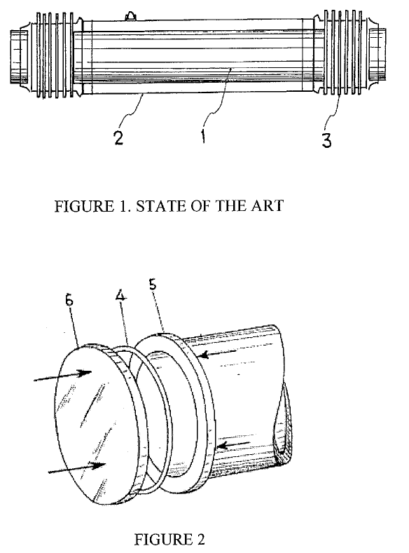

In FIG. 1, a view of an absorber tube of conventional type, and

In FIG. 2, a view of an absorber tube according to the present invention.

In these, references appearing therein have the following meanings:

1. Inner metal tube.

2. Outer glass tube.

3. Connection metal bellows.

4. Flexible metal joint.

5. Glass flange.

6. Set of metal pieces.

### DESCRIPTION OF A PREFERRED EMBODIMENT

By trying to overcome the aforementioned drawbacks for conventional absorber tubes, such as that showed in FIG. 1, in which the outer metal tube (1) and the inner glass tube (2), both coaxial, are connected through a metal bellows made of a material called Kovar®, the invention proposes, as a preferred embodiment, according to that depicted in FIG. 2, the use of a flexible metal and adaptable by compression joint, of the type called Helicoflex® (4), located between the glass flange, located at the end of the glass tube, (5) (which would carry therein the metal tube (1), not showed) and a set of metal pieces (6) ensuring, by using a mechanical force, the desirable seal between one and other, between which a high vacuum is established, which can eventually be maintained using an adequate continuous system mounted for this purpose.

There is no need to extend this description to any skilled in the art understands the scope of the present invention, as well as the technical effects and new benefits that may arise from this.

The terms in which the present specification has been written should always be taken in the broadest and less restrictive sense to be compatible with the essence of the invention therein described and claimed.

1. Sealed mechanical connection between glass and metal for receiver tubes used in solar plants, of the type using a heat-transfer fluid, characterized in that it uses a flexible metal joint (4) for high vacuum and operating at temperatures of approximately 400° C., which adapts to surfaces to which it makes contact, and by using a mechanical force ensures the seal there between, and which is located outside the glass tube between a glass flange located at the end of the glass tube (5) and set of metal pieces (6), and which has the property that in case of failure or breakage of the joint a sudden vacuum loss is not caused inside the tube, experimenting a progressive reduction of the vacuum level instead.

2. Sealed mechanical connection between glass and metal for receiver tubes used in solar plants, according to claim 1, characterized in that it eventually uses a continuous system for maintaining the necessary vacuum between both types of tubes, even in the presence of a failure or breakage of the joint.

3. A seal connection system between an outer tube and an inner tube coaxially disposed within the outer tube, the seal connection comprising:
a flange coupled to an end of the outer tube;
a set of metal pieces positioned adjacent to the flange; and
a compression joint located between the flange and the set of metal pieces.

4. The seal connection system of claim 3, wherein the compression joint is a separate component from the flange and the set of metal pieces.

5. The seal connection system of claim 3, wherein the compression joint is located outside the outer tube.

6. The seal connection system of claim 3, wherein the compression joint is configured to absorb force exerted by mechanical elements between the flange and the set of metal pieces.

7. The seal connection system of claim 3, wherein the compression joint is made of material having a working temperature of approximately 400° C.

8. The seal connection system of claim 3, wherein the compression joint adapts to surfaces to which the compression joint contacts, thereby providing a seal.

9. The seal connection system of claim 3, wherein the compression joint comprises a close-wound helical spring.

10. The seal connection system of claim 9, wherein each coil of the helical spring acts independently and allows the compression joint to conform to surface irregularities to which the compression joint contacts.

11. The seal connection system of claim 3, wherein the outer tube is a glass tube, and the inner tube is a metal tube.

12. The seal connection system of claim 3, wherein the flange is made from the same material as the outer tube.

13. A connector to maintain a vacuum level in the space between a first tube and a second tube disposed within the first tube, the connecter comprising:
a radially projecting structure coupled to the circumference of an end of the first tube;
a set of metal pieces positioned adjacent to the radially projecting structure; and
a flexible joint positioned between the radially projecting structure and the set of metal pieces, the flexible joint configured to provide a seal by conforming to surfaces of the radially projecting structure and surfaces of the set of metal pieces.

14. The connector of claim 13, wherein the first tube and the second tube are coaxial.

15. The connector of claim 13, wherein the first tube is a glass tube, and the second tube is a metal tube.

16. The connector of claim 13, wherein the radially projecting structure is made of glass.

17. The connector of claim 13, wherein the connector is configured to gradually reduce the vacuum level upon failure of the flexible joint.

18. The connector of claim 13, wherein the flexible joint is ring-shaped.

19. The connector of claim 13, wherein the flexible joint is positioned outside a vacuum zone, wherein the vacuum zone is the space between the first tube and the second tube.

20. The connector of claim 13, wherein the radially projecting structure allows the flexible joint to be pressed against the set of metal pieces via a mechanical force.
